(19) United States
(12) Patent Application Publication
(10) Pub. No.: US 2019/0196388 A1
(43) Pub. Date: Jun. 27, 2019

(54) FIXING APPARATUS, IMAGE FORMING APPARATUS, AND FIXING APPARATUS CONTROL METHOD

(71) Applicant: KONICA MINOLTA, INC., Tokyo (JP)

(72) Inventors: Yukinobu Iguchi, Hamamatsu-shi (JP); Satoru Sasaki, Toyokawa-shi (JP); Yoshihito Sasamoto, Tokyo (JP); Naoto Sugaya, Tokyo (JP); Kenichi Hayashi, Anjo-shi (JP); Yohei Yamada, Toyokawa-shi (JP)

(73) Assignee: KONICA MINOLTA, INC., Tokyo (JP)

(21) Appl. No.: 16/193,541

(22) Filed: Nov. 16, 2018

(30) Foreign Application Priority Data
Dec. 21, 2017 (JP) 2017-244975

(51) Int. Cl. G03G 15/00; G03G 15/20

(52) U.S. Cl. CPC G03G 15/80; G03G 15/2039

(57) ABSTRACT

A fixing apparatus includes: a fixing member including a heater as a heat source; and a hardware processor that uses pulse width modulation (PWM) control to control power supplied to the heater; wherein the hardware processor changes a duty of the PWM control within a half cycle of an input current of the PWM control.

The entire disclosure of Japanese patent Application No. 2017-244975, filed on Dec. 21, 2017, is incorporated herein by reference in its entirety.

### BACKGROUND

### Technological Field

The present invention relates to a fixing apparatus, an image forming apparatus, and a method for controlling the fixing apparatus. More specifically, the present invention relates to a fixing apparatus equipped with a fixing member including a heater as a heat source, and relates to an image forming apparatus, and a method for controlling the fixing apparatus.

### Description of the Related Art

An electrophotographic image forming apparatus includes: a multi function peripheral (MFP) having a scanner function, a facsimile function, a copying function, a printer function, a data communication function, and a server function; a facsimile machine; a copying machine; and a printer.

An image forming method using a general image forming apparatus is as follows. The image forming apparatus charges a photoconductor using a charging apparatus and forms an electrostatic latent image on the photoconductor by using a laser beam generated from an exposure apparatus. The image forming apparatus uses a developing apparatus to develop the electrostatic latent image to form a toner image, and then uses a transfer roller to transfer the toner image to a sheet. The image forming apparatus uses the fixing apparatus to fix the toner image on the sheet so as to form an image on the sheet.

A heater (in particular, a halogen heater) for heating the fixing member (fixing roller and fixing belt) in the fixing apparatus has a property that the resistance value of the filament increases with a temperature rise. Accordingly, the resistance value of the filament is low in a state where the heater temperature is comparatively low immediately after power supply. For this reason, immediately after power is supplied to the heater, an inrush current several times as much as the rated current momentarily flows to the heater. Thereafter, the current flowing through the heater decreases with the temperature rise of the heater and converges to the rated current or less. The inrush current flowing immediately after power is supplied to the heater causes flicker (blinking phenomenon of light generated by a fluorescent lamp or the like).

In recent years, there is a rising demand for reducing the temperature warm-up time of the fixing apparatus from the viewpoint of reducing energy consumption and reducing the time before starting printing by the image forming apparatus. In order to reduce the warm-up time of the fixing apparatus, there is a trend to use a lower heat-capacity fixing member on the fixing apparatus. With the use of a lower heat-capacity fixing member, it is possible to warm up the fixing apparatus in a shorter time. On the other hand, however, it is difficult to store sufficient thermal energy in the fixing member, leading to an increased frequency of heater switching on/off. This results in a trend of recent image forming apparatuses having increasing frequency of occurrence of flicker.

Conventional techniques capable of suppressing inrush currents are disclosed in JP 2004-191710 A and JP 2011-81143 A, for example. JP 2004-191710 A proposes soft start by using phase control. JP 2004-191710 A discloses a technique of executing phase control of the AC power by using a soft start method at power-on of a heater that generates heat by using the power supplied from an AC power supply, and after continuous execution of the phase control for a predetermined time at a predetermined duty ratio, switching to half-wave control with the same duty ratio as the predetermined duty ratio.

JP 2011-81143 A proposes soft start by using pulse width modulation (PWM) control. JP 2011-81143 A discloses an image forming apparatus including: a fixing heater temperature detection unit for detecting the temperature of a fixing heater, a fixing heater temperature control unit for inputting a temperature control signal to an inverter circuit for driving a fixing heater, a switching duty change unit for changing the on-duty of the temperature control signal in synchronization with zero cross of an input power supply, and a switching frequency change unit for changing the frequency of the temperature control signal on the basis of a detection result of the fixing heater temperature detection unit. The duty of the input PWM signal is changed in synchronization with the zero cross of the input AC power supply and is changed every half cycle of the input AC power supply.

In JP 2004-191710 A and JP 2011-81143 A, an inrush current is suppressed by applying soft start being a control of gradually increasing the power to be supplied to the heater in accordance with the elapsed time from the start of the power supply to the heater. However, this technique has a problem that, in a case where soft start is implemented, it takes time to warm up the fixing apparatus because the power supplied to the heater is small immediately after the start of power supply.

### SUMMARY

The present invention has been made to solve this problem, and an object of the present invention is to provide a fixing apparatus, an image forming apparatus, and a method for controlling a fixing apparatus, capable of reducing a warm-up time while suppressing an inrush current.

To achieve the abovementioned object, according to an aspect of the present invention, a fixing apparatus reflecting one aspect of the present invention comprises: a fixing member including a heater as a heat source; and a hardware processor that uses pulse width modulation (PWM) control to control power supplied to the heater; wherein the hardware processor changes a duty of the PWM control within a half cycle of an input current of the PWM control.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a cross-sectional view schematically illustrating a configuration of an image forming apparatus 1 according to a first embodiment of the present invention;

FIGS. 2A and 2B are diagrams illustrating a configuration of a power controller 50 according to an embodiment of the present invention;

FIG. 3 is a diagram schematically illustrating a temporal change in a current flowing through a heater in a first comparative example;

FIG. 4 is a diagram schematically illustrating a temporal change in a current flowing through a heater in a second comparative example;

FIGS. 5A and 5B are schematic diagrams respectively illustrating a temporal change in a current flowing in a heater in a first wave, and a temporal change in a duty in a first wave, according to an embodiment of the present invention;

FIG. 6 is a diagram schematically illustrating a temporal change in a current flowing through a heater according to an embodiment of the present invention;

FIG. 7 is a diagram illustrating a relationship between a value of the order n of a half cycle and a crest factor in each of an embodiment of the present invention example, the first comparative example, and the second comparative example;

FIG. 8 is a diagram illustrating a relationship between the order n of a half cycle and power supplied to a heater HT in each of an embodiment of the present invention example, the first comparative example, and the second comparative example;

FIG. 9 is a diagram illustrating a relationship between elapsed time from the start of power supply to the heater HT and the temperature of a fixing apparatus 40 in each of an embodiment of the present invention example and the second comparative example; and

FIG. 10 is a diagram schematically illustrating a plurality of relationships RL1, RL2, and RL3 of elapsed time and duty within a half cycle of an input current stored in a storage 374 in a modification of one embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

The following embodiments describe a case where the image forming apparatus on which the fixing apparatus is mounted is an MFP. The image forming apparatus on which the fixing apparatus is mounted may be a facsimile machine, a copying machine, a printer, or the like, other than an MFP, and may be for monochrome or color devices.

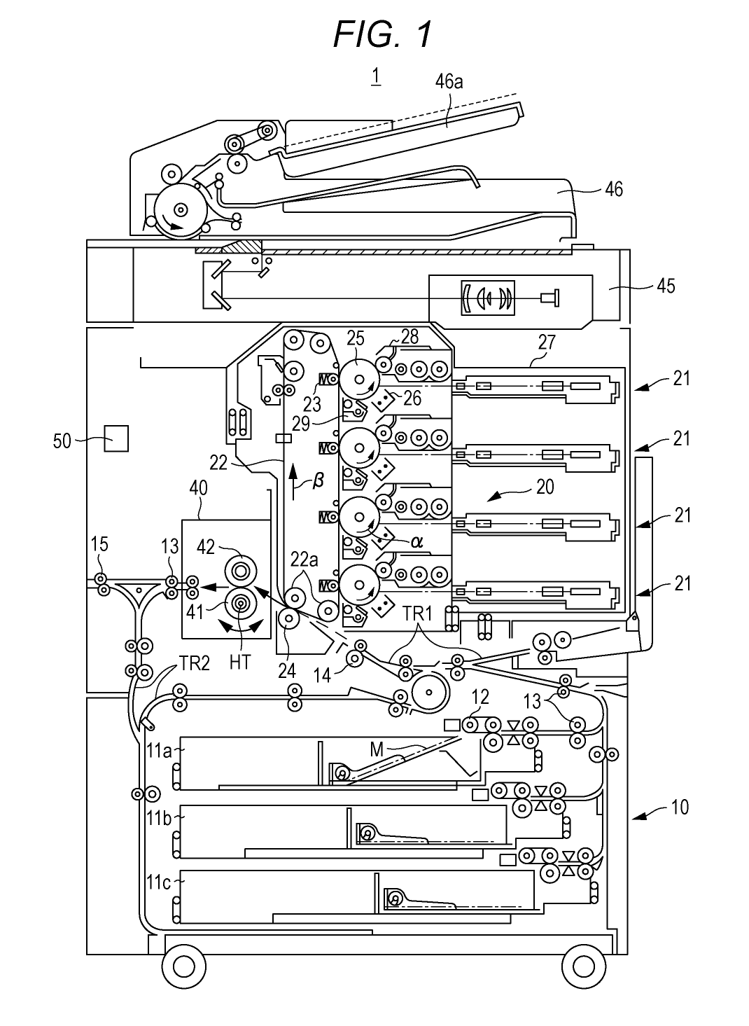

FIG. 1 is a cross-sectional view schematically illustrating a configuration of an image forming apparatus 1 according to a first embodiment of the present invention.

Referring to FIG. 1, the image forming apparatus 1 in the present embodiment is an MFP and can execute a copy job, a print job, a scan job, a fax job, a box job, or the like. The box job is a job executed by using data stored in a box (folder) provided in the image forming apparatus 1. The image forming apparatus 1 mainly includes a sheet conveyance unit 10, a toner image forming part 20 (an example of an image forming part), a fixing apparatus 40, a scanner 45, an auto document feeder (ADF) 46, and a power controller 50. The image forming apparatus 1 executes image formation on the basis of print settings. The print settings refer to a collection of setting values corresponding to a plurality of setting items related to image formation.

The sheet conveyance unit 10 conveys a sheet M (an example of a recording material) along conveyance paths TR1 and TR2. The sheet conveyance unit 10 includes a plurality of sheet feeding trays 11a to 11c, a sheet feeding roller 12, a conveyance roller 13, a registration roller 14, and a sheet discharge roller 15. The plurality of sheet feeding trays 11a to 11c each accommodates sheet on which an image is to be formed. There may be a plurality of sheet feeding trays or a single sheet feeding tray. The sheet feeding roller 12 is arranged between each of the sheet feeding trays 11a to 11c and the conveyance path TR1. The conveyance roller 13 and the registration roller 14 are provided along the conveyance path TR1. The sheet discharge roller 15 is provided at a most downstream portion of the conveyance path TR1.

The toner image forming part 20 combines images of four colors of yellow (Y), magenta (M), cyan (C), and black (K) by a tandem system to form a toner image on the sheet M conveyed. The toner image forming part 20 forms an image on the sheet M supplied from the sheet conveyance unit 10 on the basis of read data generated by the scanner 45 or print data obtained from the outside by an interface unit of the controller 37. The toner image forming part 20 includes an image forming unit 21 for each of colors of Y, M, C, and K, an intermediate transfer belt 22, a primary transfer roller 23 for each of colors of Y, M, C, and K, and a secondary transfer roller 24.

The image forming unit 21 for each of the colors of Y, M, C, and K includes a photoconductive dram 25, a charging apparatus 26, an exposure apparatus 27, a developing apparatus 28, and a cleaning apparatus 29. The photoconductive drum 25 is rotationally driven in a direction indicated by an arrow a in FIG. 1. The photoconductive drum 25 is surrounded by the charging apparatus 26, the developing apparatus 28, and the cleaning apparatus 29. The exposure apparatus 27 is provided at a right-hand side of the photoconductive drum 25.

The intermediate transfer belt 22 is provided at the left-hand side of the image forming units 21 of individual colors of Y, M, C, and K. The intermediate transfer belt 22 is annular, and is disposed across a rotating roller 22a. The intermediate transfer belt 22 is rotationally driven in a direction indicated by an arrow in FIG. 1. Each of the primary transfer rollers 23 for each of colors of Y, M, C, K faces each of the photoconductive drums 25 with the intermediate transfer belt 22 interposed therebetween. The secondary transfer roller 24 is in contact with the intermediate transfer belt 22 in the conveyance path TR1.

The fixing apparatus 40 conveys a sheet M on which a toner image is formed while gripping the sheet M with a fixing nip, and thereby fixes the toner image on the sheet M. The fixing apparatus 40 includes a fixing roller 41 (an example of a fixing member) and a pressure roller 42. The fixing roller 41 and the pressure roller 42 are pressed against each other to form a nip portion (fixing nip portion). The toner image is fixed by passing the sheet through the fixing nip portion. The fixing roller 41 internally includes a heater HT as a heat source of the fixing roller 41. The heater HT includes a halogen heater, for example.

The scanner 45 is disposed between the ADF 46 and the toner image forming part 20. The scanner 45 reads an image of the document conveyed by the ADF 46, and generates read data.

The ADF 46 is provided above the scanner 45. The ADF 46 automatically conveys the document placed on a document table 46a to a reading position of the scanner 45.

The power controller 50 controls power to be supplied to each of members of the image forming apparatus 1.

The image forming apparatus 1 rotates the photoconductive drum 25 to charge the surface of the photoconductive drum 25 with the charging apparatus 26. The image forming apparatus 1 applies laser light by the exposure apparatus 27 onto a surface of the charged photoconductive drum 25 so as to form an electrostatic latent image on the surface of the photoconductive drum 25.

Next, the image forming apparatus 1 supplies toner from the developing apparatus 28 to the photoconductive drum 25 on which an electrostatic latent image is formed, and then performs development so as to form a toner image corresponding to the electrostatic latent image, on the surface of the photoconductive dram 25.

Next, the image forming apparatus 1 causes the primary transfer roller 23 to sequentially transfer the toner image formed on the photoconductive drum 25 to the surface of the intermediate transfer belt 22 (primary transfer). In the case of a full-color image, the image forming units 21 of individual colors of Y, M, C, and K operate in synchronized timings with each other, so as to form a toner image in which toner images of the individual colors of Y, M, C, and K are combined, on the surface of the intermediate transfer belt 22. The image forming apparatus 1 causes the cleaning apparatus 29 to remove the toner remaining on the surface of the photoconductive drum 25 without being transferred to the intermediate transfer belt 22.

Subsequently, the image forming apparatus 1 rotates the intermediate transfer belt 22 to convey the toner image formed on the surface of the intermediate transfer belt 22 to a position facing the secondary transfer roller 24.

Meanwhile, the image forming apparatus 1 causes the sheet feeding roller 12 to feed a sheet accommodated in one of the sheet feeding trays 11a to 11c and causes the conveyance roller 13 to convey the sheet along the conveyance path TR1. The image forming apparatus 1 the causes the registration roller 14 to correct the tilt of the sheet and then guides the sheet to a portion between the intermediate transfer belt 22 and the secondary transfer roller 24 at a predetermined timing. Then, the image forming apparatus 1 causes the secondary transfer roller 24 to transfer the toner image formed on the surface of the intermediate transfer belt 22 to the surface of the sheet M.

The image forming apparatus 1 guides the sheet M on which a toner image is formed to the fixing apparatus 40, and causes the fixing apparatus 40 to fix the toner image onto the surface of the sheet M. Thereafter, the image forming apparatus 1 causes the conveyance roller 13 to convey the sheet M on which the toner image is fixed, to the downstream side.

In the case of single-sided printing, the image forming apparatus 1 causes the sheet discharge roller 15 to discharge the sheet M having the toner image fixed on its surface as it is to the outside of the image forming apparatus 1. In the case of duplex printing, the image forming apparatus 1 guides the sheet M having the toner image formed on its surface to a reversing path TR2. The image forming apparatus 1 guides the sheet M to the conveyance path TR1 again from a joining position with the reversing path TR2 provided on more toward the downstream side than the secondary transfer roller 24 in the conveyance path TR1. Thereafter, the image forming apparatus 1 causes the toner image forming part 20 to form a toner image on the back surface of the sheet M, causes the fixing apparatus 40 to fix the toner image on the back side of the sheet M, and causes the sheet discharge roller 15 to discharge the sheet to the outside of the image forming apparatus 1.

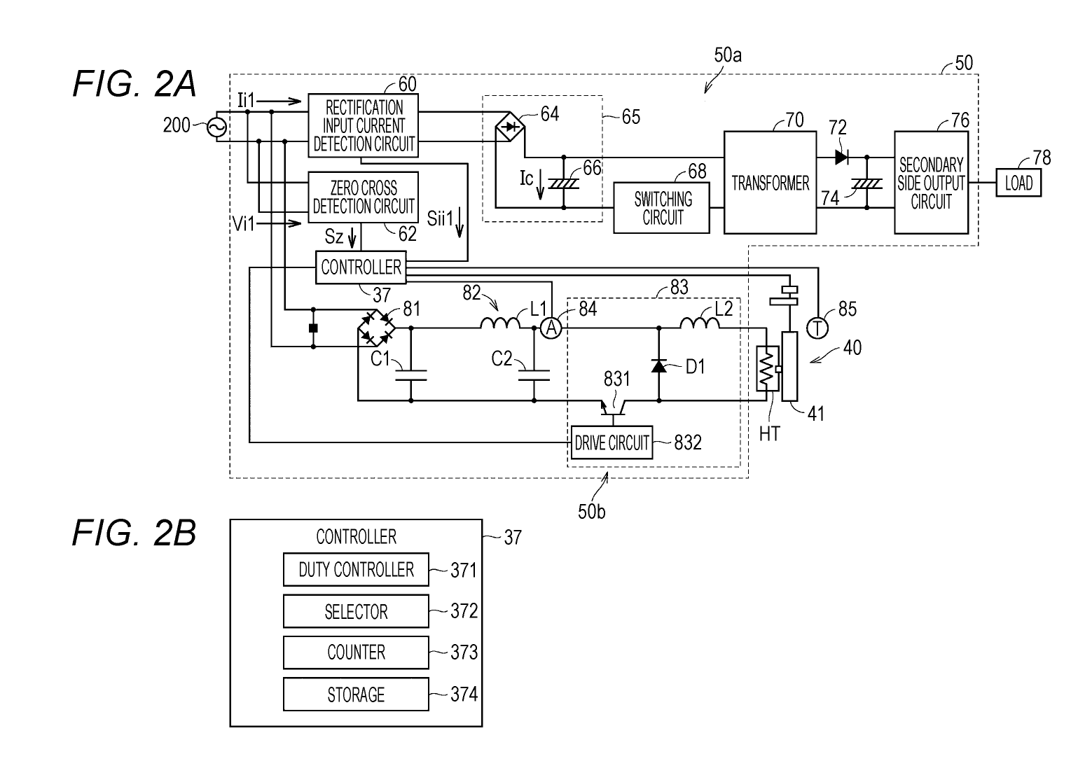

FIGS. 2A and 2B are diagrams illustrating a configuration of a power controller 50 according to an embodiment of the present invention. FIG. 2A is a circuit diagram illustrating a configuration of the power controller 50. FIG. 2B is a block diagram illustrating a functional configuration of the controller 37.

With reference to FIGS. 2A and 2B, the power controller 50 includes a DC power control device 50a, an AC power control device 50b, and a controller 37 (an example of controller).

The DC power control device 50a includes a rectification input current detection circuit 60, a zero cross detection circuit 62, a capacitor input type rectifier circuit 65, a switching circuit 68, a transformer 70, a diode 72, a smoothing capacitor 74, and a secondary side output circuit 76.

The rectifier circuit 65 rectifies the AC power output from a AC power supply 200 (an example of a power supply) and outputs a resulting DC power to a load 78. The rectifier circuit 65 includes: a bridge diode 64 formed with four diodes; and a smoothing capacitor 66.

AC power output from the AC power supply 200 is full-wave rectified by the bridge diode 64 and smoothed by the smoothing capacitor 66. A charging current Ic flows through the smoothing capacitor 66. The output from the rectifier circuit 65 goes through the switching circuit 68, the transformer 70, the diode 72, and the smoothing capacitor 74 to be adjusted to a stable DC voltage, and goes through the secondary side output circuit 76 to be output to the load 78.

The rectification input current detection circuit 60 detects a current Ii1 of the AC power output from the AC power supply 200 and input to the rectifier circuit 65, and then, outputs a signal Sii1 corresponding to the current Ii1, to the controller 37.

The zero cross detection circuit 62 detects a timing at which the AC voltage Vi1 output from the AC power supply 200 is switched between a positive value and a negative value, and outputs a signal Sz indicating the detection result to the controller 37.

The AC power control device 50b outputs power obtained by performing PWM control of applying amplitude modulation on AC power from the AC power supply 200, to the heater HT. The AC power control device 50b includes a rectifier circuit 81 (an example of a rectifier circuit), a filter 82, a chopper circuit 83, an ammeter 84 (an example of a current measurement part), a thermometer 85 (an example of a temperature detector).

The rectifier circuit 81 is connected to the AC power supply 200 and rectifies the AC current output from the AC power supply 200.

The filter 82 is, for example, a H type filter, and is cascade-connected to the output side of the rectifier circuit 81. The filter 82 includes a coil L1 and capacitors C1 and C2. The coils L1 and L2, the heater HT, and a switching device 831 of the chopper circuit 83 are connected in series in this order. The capacitors C1 and C2 are connected in parallel to the heater HT.

The chopper circuit 83 is a step-down chopper circuit, for example, being cascade-connected to the output side of the filter 82. The heater HT is connected between the output terminals of the chopper circuit 83. The chopper circuit 83 includes a coil L2 (an example of a reactor), a flyback device D1, a switching device 831, and a drive circuit 832. The chopper circuit 83 can operate (turning on/off) of the switching device 831 to control the current flowing through the heater HT. The coil L2 is connected in series between the coil L1 and the heater HT. The flyback device D1 is a diode, for example, and is connected in parallel with the heater HT, at a position between the coil L1 and the coil L2. More specifically, the cathode of the flyback device D1 is connected between the coil L1 and the coil L2, and the anode of the flyback device D1 is electrically connected between the heater HT and the collector of the switching device 831. The switching device 831 is, for example, an insulated gate bipolar transistor (IGBT) or a metal-oxide-semiconductor field-effect transistor (MOS-FET). A collector of the switching device 831 is connected to the heater HT, and an emitter of the switching device 831 is connected to the output side of the rectifier circuit 81.

The drive circuit 832 is connected to a gate of the switching device 831. The drive circuit 832 drives the switching device 831 under the control of the controller 37.

The ammeter 84 is connected between the coil L1 and the coil L2. The ammeter 84 is used to measure a value of an input current of the PWM control in a modification to be described below, and outputs the measured value to the controller 37.

The thermometer 85 detects the temperature of the fixing roller 41 and outputs the detected temperature to the controller 37.

The controller 37 uses the drive circuit 832 to control the operation of the switching device 831, thereby controlling the power supplied to the heater HT by using the PWM control. The controller 37 includes a duty controller 371 (an example of a selection controller), a selector 372 (an example of a selector), a counter 373 (an example of a counter), a storage 374 (an example of a storage device).

The duty controller 371 sets the duty of the PWM control of the heater HT.

The selector 372 selects one relationship among a plurality of relationships between the elapsed time and the duty within the half cycle of the input current stored in the storage 374 in a modification described below.

The counter 373 counts the elapsed time from a point when the power supplied to the heater HT is most recently stopped in the modification described below.

The storage 374 stores various types of information such as the relationship between the elapsed time and the duty within the half cycle of the input current.

The controller 37 detects a half cycle of the input current of the PWM control by using the timing detected by the zero cross detection circuit 62. The controller 37 sets the duty of the PWM control and the drive frequency of the switching device 831 on the basis of the detected half cycle, and transmits these setting values to the drive circuit 832. The duty of the PWM control is set on the basis of a table stored in the storage 374, the value of the input current of the PWM control measured by the ammeter 84, the temperature of the fixing roller 41 measured by the thermometer 85, or the like.

Subsequently, a method for controlling the power supplied to the heater HT in the present embodiment will be described in comparison with a comparative example.

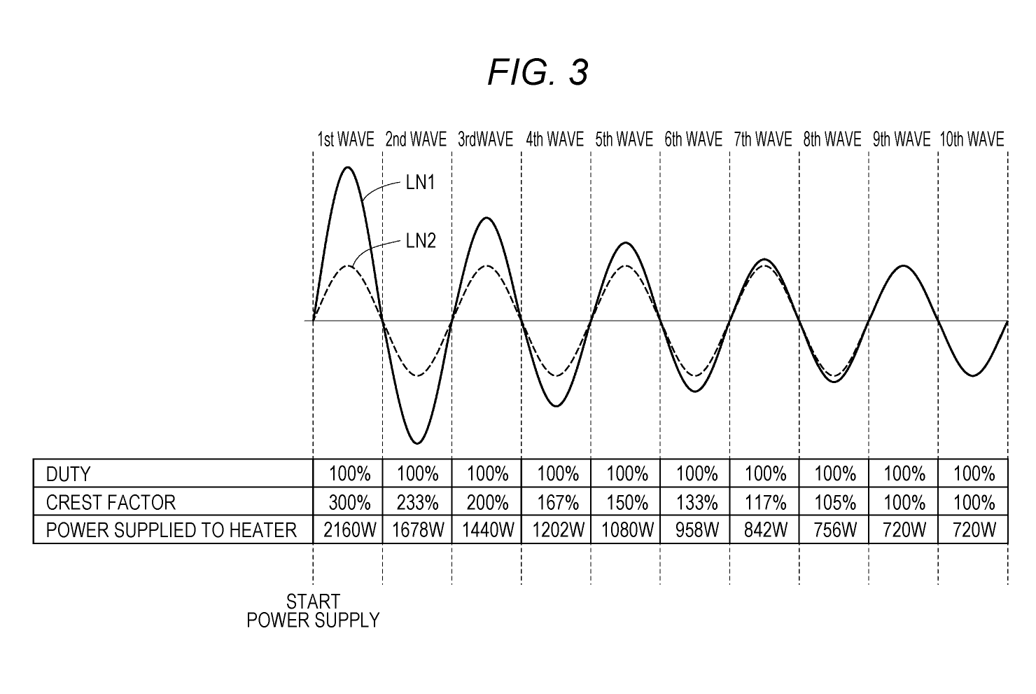

FIG. 3 is a diagram schematically illustrating a temporal change in the current flowing through the heater HT in a first comparative example. In FIGS. 3 to 6, the rated power of the heater HT is 720 W, the rated voltage is 100V, and the rated current is 7.2 A. In the following description, the order of the half cycle of the input current of the PWM control from the start of the power supply to the heater HT will be represented as the n-th wave (n is a natural number).

Referring to FIG. 3, the first comparative example is an exemplary case where power is supplied to heater HT under the condition that the switching device 831 is constantly turned on (without control by the controller 37). A waveform LN1 represents a current (periodically fluctuating DC current) flowing through the heater HT in the first comparative example, being the current corresponding to the input current of the PWM control in the present embodiment. A waveform LN2 represents a steady current of the current flowing through the heater HT.

In the first comparative example, an inrush current with a high crest factor of 300% flows through the heater HT at the first wave immediately after power is supplied to the heater HT. The inrush current is attributed to the state immediately after power supply where the temperature of the heater HT is comparatively low and therefore the resistance value of the filament of the heater HT is low. In accordance with the lapse of time from the start of the power supply to the heater HT, the temperature of the filament rises and the resistance value of the filament increases, causing the crest factor of the current flowing through the heater HT to converge to 100%. In the ninth and subsequent waves, a rated current with a crest factor of 100% flows through the heater HT.

Note that the crest factor represents the ratio of the effective current flowing through the heater HT to the steady current of the PWM-controlled input current.

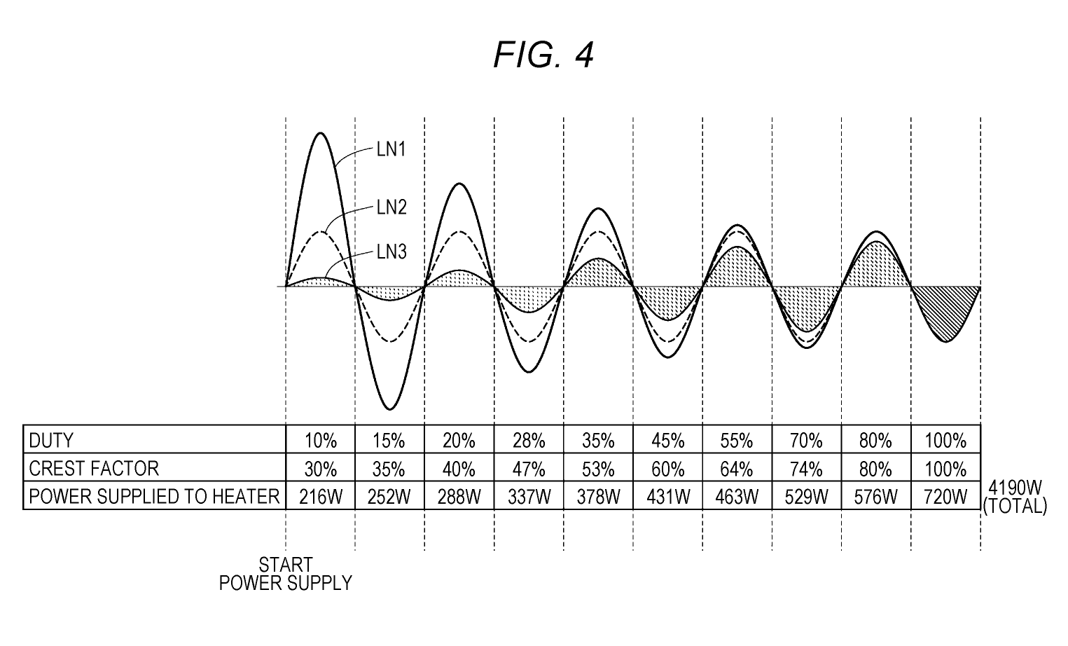

FIG. 4 is a diagram schematically illustrating temporal changes in the current flowing through the heater HT in a second comparative example.

Referring to FIG. 4, the second comparative example is an exemplary case where the power is supplied to heater HT under the condition (conventional PWM control condition) that performs soft start while keeping the duty within a half cycle of the input current of PWM control at a constant value. A waveform LN3 represents a current flowing through the heater HT in the second comparative example. Since the duty within the half cycle of the input current of the PWM control is kept to a constant value in the second comparative example, the waveform LN3 becomes the same sine wave as the waveform LN1.

In the second comparative example, the duty is set to 10% within the first wave. As a result, the crest factor in the first wave is 30%, and the power supplied to the heater HT in the first wave is 216 W. In the first and subsequent waves, the duty within the half cycle is increased to 15%, 20%, 28%, . . . , at each of timings when a time corresponding to a half cycle of the input current of the PWM control elapses. As a result, the crest factor within the half cycle increases to 35%, 40%, 47%, . . . , also increasing the power supplied to the heater HT. In the tenth wave and beyond, the duty within the half cycle is set to 100%. As a result, the crest factor of the tenth wave and thereafter is 100%, and the power supplied to the heater HT is 720 W. In the second comparative example, the total value of the power supplied to the heater HT (output voltage of the heater HT) during the time (first wave to tenth wave) until the inrush current converges to a steady current, is 4190 W.

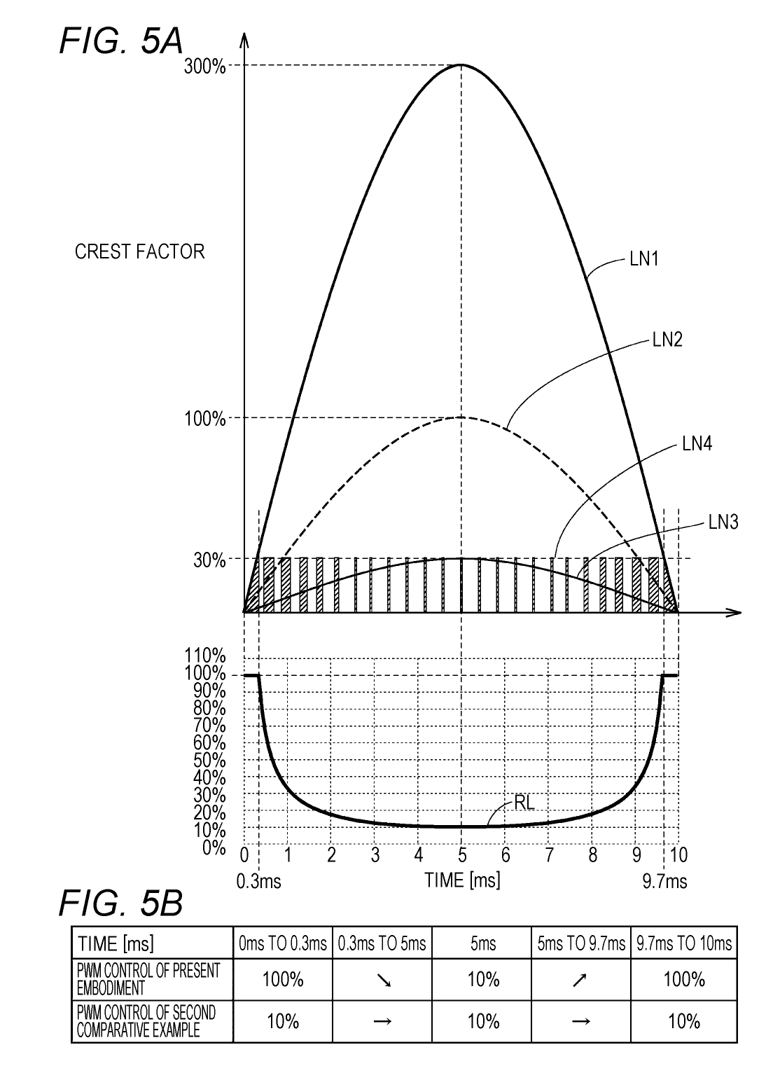

FIGS. 5A and 5B are schematic diagrams respectively illustrating a temporal change in a current flowing in the heater HT in a first wave and a temporal change in a duty in the first wave, according to an embodiment of the present invention. FIG. 5A is a diagram illustrating a temporal change in the current flowing through the heater HT within the first wave. FIG. 5B is a diagram schematically illustrating a relationship between the elapsed time and the duty in the first wave. Note that the length of the half cycle of the input current of the PWM control in FIGS. 5A and 5B is 10 ms.

With reference to FIGS. 5A and 5B, the controller 37 in the present embodiment supplies power to the heater HT under a condition of performing soft start while varying the duty within a half cycle of the input current of the PWM control. The controller 37 maintains the crest factor within a half cycle of the input current of the PWM control to be constant and increases a lower limit value of the duty within the n-th wave in accordance with the increase of n.

Specifically, the controller 37 preliminarily stores a relationship RL (FIG. 5B) between the elapsed time and the duty within the half cycle of the input current into the storage 374, and then sets the duty of the PWM control in accordance with this relationship. A waveform LN4 represents a current flowing through the heater HT in the present embodiment.

In the present embodiment, the lower limit value of the duty is set to 10% within the first wave, and the duty is changed within the range of 10% to 100%. The change in the duty within the first wave is divided into the following first to fifth sections.

In the first section (section of elapsed time from 0 ms to 0.3 ms), the duty is set to a local maximum (here, 100%). The value of the sine wave input current (waveform LN1) is low in this section, and thus, a large amount of current would not flow through the heater HT even when the duty is set to 100%.

In the second section (section of elapsed time from 0.3 ms to 5 ms), the duty is gradually decreased from the local maximum. Since the input current gradually increases in this section, the duty is decreased in accordance with the increase of the input current.

In the third section (section of elapsed time of 5 ms), the duty is set to a local minimum. In this section, the input current takes its local maximum, and thus, setting the duty to the lower limit value of 10% minimizes the current flowing through the heater HT.

In the fourth section (the section of elapsed time from 5 ms to 9.7 ms), the duty is gradually increased from the local minimum. Since the input current gradually decreases in this section, the duty is increased with the decrease of the input current.

In the fifth section (section of elapsed time of 9.7 ms to 10 ms), the duty is set to the local maximum (100% in the first wave). The value of the sine wave input current is low in this section, and thus, a large amount of current would not flow through the heater HT even when the duty is set to 100%.

As a result of the above control, the waveform LN4 has a trapezoidal shape, and the crest factor of the first wave to the tenth wave is maintained at 30% which is the same as that of the second modification. Note that the crest factor in the half cycle need not necessarily be a constant value but may vary.

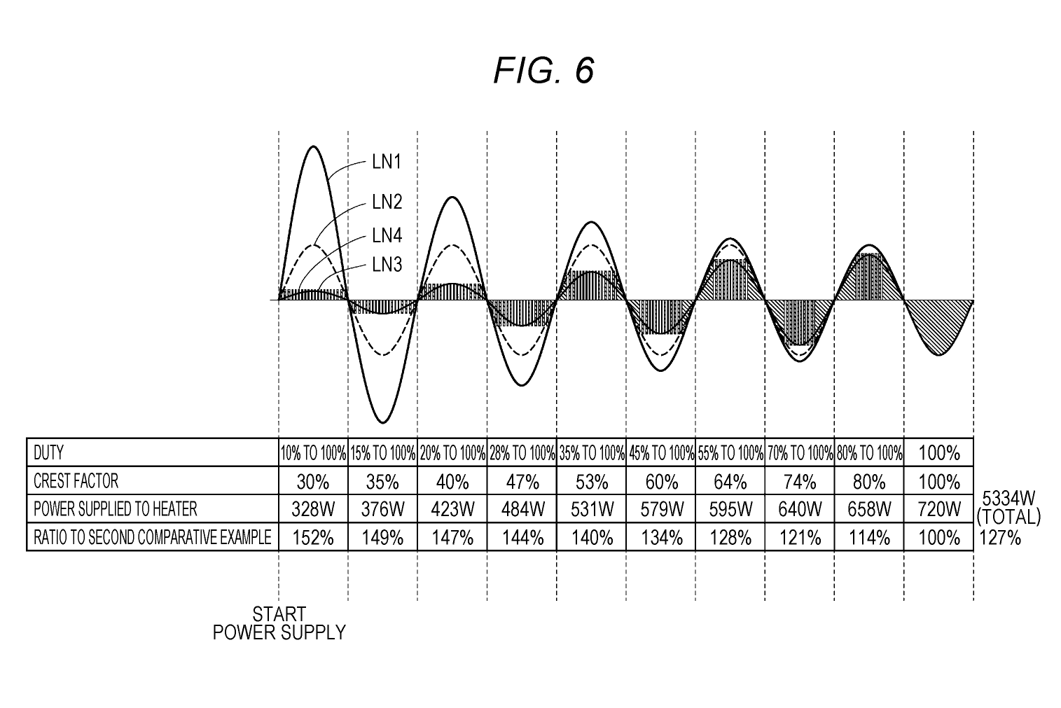

FIG. 6 is a diagram schematically illustrating a temporal change in a current flowing through the heater HT according to an embodiment of the present invention.

With reference to FIG. 6, in the present embodiment, the duty is set to 10% to 100% (the lower limit value of the duty is set to 10%) within the first wave. As a result, the crest factor in the first wave is 30%, and the power supplied to the heater HT in the first wave is 152 W. Even after the first wave, the PWM control is performed in a similar manner as the PWM control in the first wave illustrated in FIG. 5B. In the first and subsequent waves, the lower limit value of the duty within the half cycle is increased to 15%, 20%, 28%, . . . , at a lapse of each of periods corresponding to a half cycle of the input current of the PWM control (in other words, the lower limit of the duty is increased in accordance with an increase of n). As a result, the crest factor within the half cycle increases to 35%, 40%, 47%, . . . , also increasing the power supplied to the heater HT. In the tenth and subsequent waves, the duty and crest factor within the half cycle are set to 100%. As a result, the power supplied to the heater HT after the tenth wave is 720 W. In the present embodiment, the total value of the power (output voltage of the heater HT) supplied to the heater HT during the time between first and tenth waves, which is the time until the inrush current converges to the steady current, is 5334 W, being 27% higher than in the second comparative example.

According to the present embodiment, it is possible to increase the output power of the heater HT while suppressing the crest factor in the half cycle of the input current of the PWM control to the level of the conventional soft start. As a result, it is possible to reduce the temperature warm-up time of the fixing apparatus 40 while suppressing the inrush current, achieving suppression of power consumption of the image forming apparatus. According to the present embodiment, it is possible to increase the output voltage of the heater HT by effectively utilizing the inrush current which rises and falls early as the current flowing to the heater HT. Hereinafter, effects of the present embodiment will be specifically described.

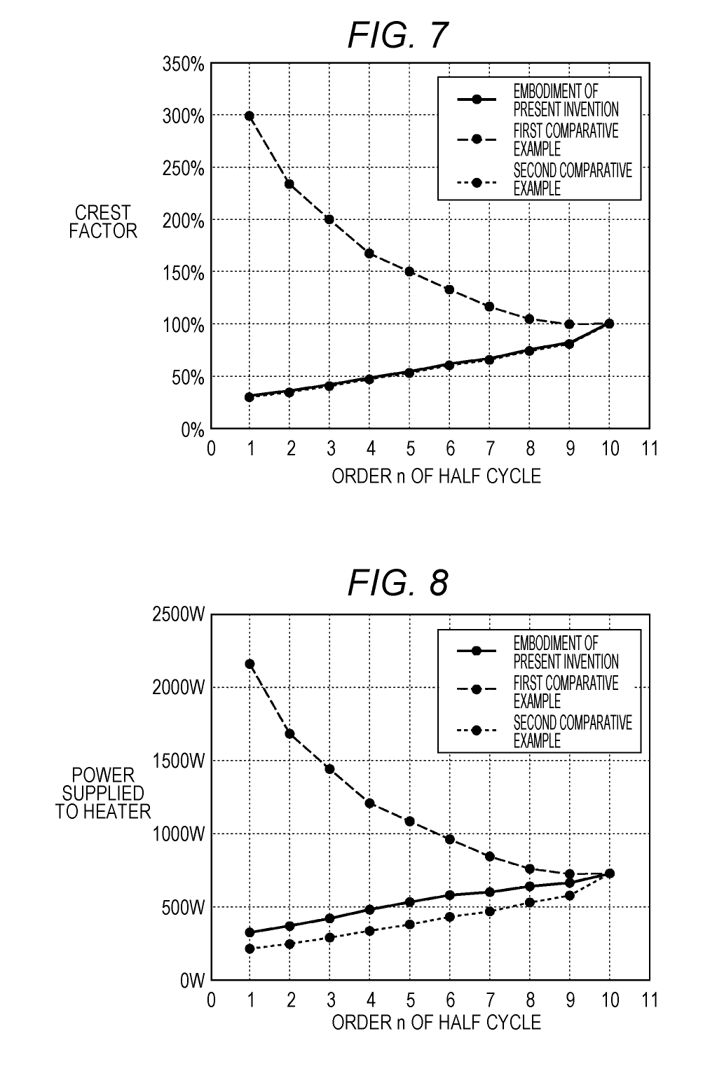

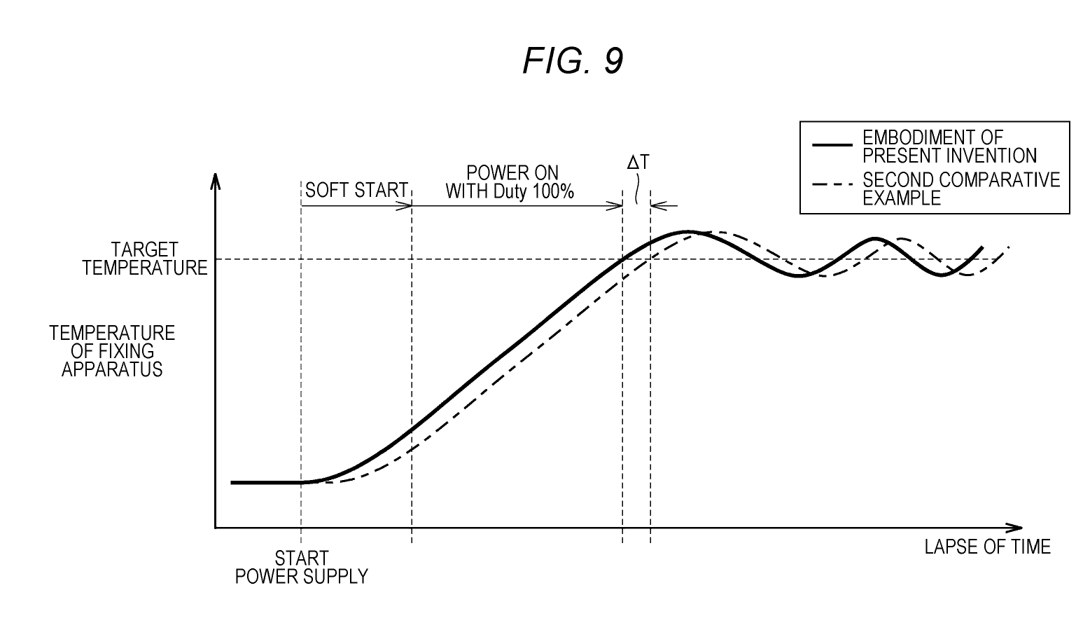

FIG. 7 is a diagram illustrating a relationship between a value of the order n of a half cycle and a crest factor in each of an embodiment of the present invention example, the first comparative example, and the second comparative example. FIG. 8 is a diagram illustrating a relationship between the order n of a half cycle and power supplied to a heater HT in each of an embodiment of the present invention example, the first comparative example, and the second comparative example. FIG. 9 is a diagram illustrating a relationship between elapsed time from the start of power supply to the heater HT and the temperature of a fixing apparatus 40 in each of an embodiment of the present invention example and the second comparative example.

Referring to FIG. 7, the crest factor within a half cycle of each of the first to tenth waves in an embodiment of the present invention is equal to the crest factor within a half cycle of each of the first to tenth waves in the second comparative example. From this result, it can be seen that the crest factor in the half cycle of the input current of the PWM control can be suppressed to the level of the conventional soft start, making it possible suppress the inrush current.

Referring to FIG. 8, the power supplied to heater HT in each of the first wave to the tenth wave in the present embodiment is higher than the power supplied to the heater HT in each of the first wave to the tenth wave in the second comparative example. From this result, it can be seen that the output power of the heater HT is successfully increased.

Referring to FIG. 9, the elapsed time from the start of the power supply to the heater HT to the time when the temperature of the fixing apparatus 40 reaches a target temperature is shorter by time AT in the embodiment of the present invention than in the second comparative example. From this result, it can be seen that the warm-up time of the fixing apparatus 40 is successfully reduced.

[Others]

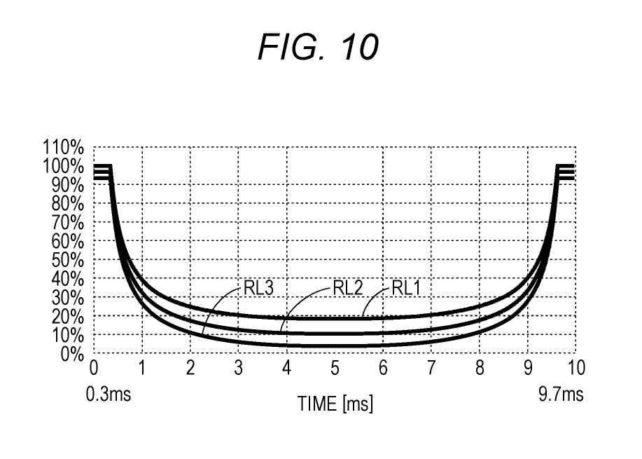

FIG. 10 is a diagram schematically illustrating a plurality of relationships RL1, RL2, and RL3 of elapsed time and the duty within a half cycle of an input current stored in the storage 374 in a modification of one embodiment of the present invention. Although the relationship within the first wave is simply illustrated in FIG. 10, each of the plurality of relationships RL1, RL2, and RL3 is result of actually defining the relationship between the elapsed time until an inrush current converges to a steady current (period from the first wave to the tenth wave) and the duty within a half cycle of the input current.

Referring to FIG. 10, as an alternative method for setting the duty, the controller 37 may store the plurality of relationships RL1, RL2, and RL3 of the elapsed time and the duty within the half cycle of the input current, into the storage 374.

The controller 37 may use the selector 372 to select one of the plurality of relationships RL1, RL2, and RL3 stored in the storage 374 on the basis of the temperature detected by the thermometer 85, and may use the duty controller 371 to set the duty on the basis of the selected relationship.

Alternatively, the controller 37 may use the selector 372 to select one of the plurality of relationships RL1, RL2, and RL3 stored in the storage 374 on the basis of the time counted by the counter 373 and may use the duty controller 371 to set the duty on the basis of the selected relationships.

Note that the lower the temperature detected by the thermometer 85 or the longer the time counted by the counter 373, the higher the possibility of occurrence of greater inrush current. Accordingly, it is more desirable to select the relationship in which the duty is set to a lower value (corresponding to the relationship RL3 among the relationships RL1, RL2, and RL3).

As another modification, the controller 37 may set the duty of the PWM control on the basis of the value of the input current of the PWM control measured by the ammeter 84.

The circuit configuration for implementing the PWM control of the heater HT may be other than those described above. The rectifier circuit may have any configuration, and it may be a half-wave rectifier circuit in addition to the full-wave rectifier circuit as in the above-described embodiment. The input current of the PWM control may be an AC current.

Although embodiments of the present invention have been described and illustrated in detail, the disclosed embodiments are made for purposes of illustration and example only and not limitation. The scope of the present invention should be interpreted by terms of the appended claims. The scope of the present invention is intended to include all modifications within the meaning and scope, which are equivalent to the scope of claims.

What is claimed is:

1. A fixing apparatus comprising:
a fixing member including a heater as a heat source; and
a hardware processor that uses pulse width modulation (PWM) control to control power supplied to the heater,
wherein the hardware processor changes a duty of the PWM control within a half cycle of an input current of the PWM control.

2. The fixing apparatus according to claim 1,
wherein in a case where an order of the half cycle of the input current from a start of the power supply to the heater is represented as an n-th wave (n is a natural number),
the hardware processor increases a lower limit value of the duty within the n-th wave in accordance with an increase of n.

3. The fixing apparatus according to claim 1,
wherein the hardware processor maintains a crest factor to be constant during the half cycle of the input current, and
the crest factor is a ratio of an effective current flowing through the heater to a steady current of the input current.

4. The fixing apparatus according to claim 1,
wherein the hardware processor further stores a relationship between an elapsed time and the duty within the half cycle of the input current, and
the hardware processor sets the duty in accordance with the relationship stored in the hardware processor.

5. The fixing apparatus according to claim 4, further comprising a temperature detector that detects a temperature of the fixing member,
wherein the hardware processor stores a plurality of the relationships, and
the hardware processor
selects one relationship out of the plurality of relationships stored in the hardware processor on the basis of the temperature detected by the temperature detector, and
sets the duty on the basis of the relationship selected by the hardware processor.

6. The fixing apparatus according to claim 4,
wherein the hardware processor stores a plurality of the relationships, and
the hardware processor
counts an elapsed time from a point when a power supplied to the heater is most recently stopped,
selects one relationship out of the plurality of relationships stored in the hardware processor on the basis of the elapsed time counted by the hardware processor, and
sets the duty on the basis of the relationship selected by the hardware processor.

7. The fixing apparatus according to claim 1, further comprising a current measurement part that measures a value of the input current,
wherein the hardware processor sets the duty of the PWM control on the basis of the value of the input current measured by the current measurement part.

8. The fixing apparatus according to claim 1, further comprising:
a rectifier circuit that rectifies an AC current output from a power supply; and
a chopper circuit including a reactor, a flyback device, and a switching device, the chopper circuit being capable of controlling a current flowing through the heater by operation of the switching device,
wherein the hardware processor controls the operation of the switching device.

9. The fixing apparatus according to claim 1, further comprising a zero cross circuit that detects a timing of switching of an AC voltage output from a power supply between a positive value and a negative value,
wherein the hardware processor sets the duty of the PWM control on the basis of the half cycle of the input current detected by using the timing detected by the zero cross circuit.

10. The fixing apparatus according to claim 1,
wherein the change in the duty within the half cycle of the input current of the PWM control is divided into:
a first section having the duty set to a local maximum;
a second section coming immediately after the first section and having the duty gradually decreasing from the local maximum;
a third section coming immediately after the second section and having the duty set to a local minimum;
a fourth section coming immediately after the third section and having the duty gradually increasing from the local minimum; and
a fifth section coming immediately after the fourth section and having the duty set to a local maximum.

11. An image forming apparatus comprising:
an image forming part that forms a toner image on a recording material; and
the fixing apparatus according to claim 1 that fixes the toner image formed by the image forming part on the recording material.

12. A method for controlling a fixing apparatus equipped with a fixing member including a heater as a heat source, the method comprising
controlling power supplied to the heater by using pulse width modulation (PWM) control,
wherein, in the controlling, a duty of the PWM control is changed within a half cycle of an input current of the PWM control.
